(19) United States
(12) Patent Application Publication
(10) Pub. No.: US 2008/0208649 A1
(43) Pub. Date: Aug. 28, 2008

(54) Secure information sharing architecture, processes and tools for post merger integration

(75) Inventors: Kristin L. Ficery, Atlanta, GA (US); Meng Yen Ti, Bagio Villa (HK); Karen Lindgren, Chicago, IL (US); David Goldson, Livingston, NJ (US); Michael J. Russell, King County, GA (US); Andrew Zimmerman, New York, NY (US); Tera McCallum, Raytown, MO (US); P. Christopher Bosco, Overland Park, KS (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 11/711,161

(22) Filed: Feb. 27, 2007

(51) Int. Cl. G06F 9/44

(52) U.S. Cl. 705/7

(57) ABSTRACT

Disclosed herein are architectures and related processes and tools for enabling secure information sharing during the regulatory review period of mergers and acquisitions. A secure information sharing architecture and related processes and tools is provided that facilitates data gathering and information organizing to accelerate the post merger integration process for companies involved in a merger transaction while ensuring that information integrity is maintained in compliance with regulatory restrictions. Embodiments of the invention permit a mirrored approach to integration research and planning.

### FIELD OF THE INVENTION

The present invention relates to an architecture and related processes and tools for enabling secure information sharing during the regulatory review period of mergers and acquisitions. More particularly, the present invention pertains to a secure information sharing architecture and related processes and tools for facilitating data gathering and information organizing to accelerate the post merger integration process for companies involved in a merger transaction while ensuring that information integrity is maintained in compliance with regulatory restrictions.

### BACKGROUND OF THE INVENTION

Mergers are common characteristics of our modern market economies dominated by corporations and other large companies. Companies continuously are trying to maintain or enhance profitability, and one mechanism for doing so is finding synergies that can be obtained from other companies. Advantageous economies of scale, vertical integration with suppliers and distributors, or horizontal integration with entities competing in or providing complementary goods or services to the same market are all examples of the types of synergies that can be established. Business and corporate mergers and acquisitions are frequent occurrences in many markets and industries exactly because they are seen as mechanisms for obtaining synergies relatively quickly and safely. Currently, mergers are becoming more and more complex with the involved companies often being large and diverse, and potentially leveraging much of their fiscal health and growth upon the success of the merger.

While success of the merger is of paramount importance to both companies, it also remains important for merger activities to be segregated from day to day activities of both companies involved. First, the merger cannot become an ongoing distraction in daily operations for the two companies. Second, regulatory restrictions imposed by the U.S. Securities and Exchange Commission (“SEC”) requires mergers to be submitted for approval. Pending such approval, certain restrictions apply, including a bar on any potentially anti-competitive collaboration between the merging companies. The Hart-Scott-Rodino Act in particular prohibits the sharing of information between merging entities until the deal has gained regulatory approval and is officially closed. Further, for mergers of extremely large scale, regulatory approval is not only required from the SEC but also the U.S. Department of Justice to resolve any concerns with respect to the antitrust laws. Such approvals must be obtained before the merger is allowed to proceed, thus generally delaying the post-merger activities of the companies.

Generally, merger transactions can be conceptualized as evolving according to a typical lifecycle that includes various overlapping but distinguishable pre-deal phases and post-deal phases. An example of a post-deal portion of a merger transaction lifecycle timeline 100 is depicted in FIG. 1. As shown in the drawing, immediately following the announcement 105 of the deal, the post-deal phases 101-104 begin. The first post-deal phase includes the establishing of the merger architecture 101, wherein the high level managers of the merging companies make critical decisions regarding the business case for the merger, including what synergies to target for exploitation and general decisions on integration direction. This phase 101 is very early after the deal has been made and typically does not last very long. The next phase typically begins with the establishing of a merger integration team at 106, which team is comprised of select managers from the acquirer company, and sometimes hired third parties and members of the acquiree company. This phase comprises more detailed pre-approval planning 102, wherein the merger integration team works on setting priorities and work plans for the integration and, to the extent possible given regulatory restrictions, attempts to make critical decisions that are required for the eventual integration of the two companies. Importantly, it is during the pre-merger planning phase 102 that the lengthy regulatory approval process 109 generally is begun.

When regulatory permission is obtained, the deal closing process 110 can finally begin, signaling the commencement of the design integration post-deal phase 103 of the post-deal timeline portion 100. This phase 103 commonly includes a flurry of kick-off decision making activities, typically performed by a dedicated joint merger team 107 containing representatives from both companies. It is only once this phase begins (i.e., following closing of the deal 110) that the merging companies will be able to collaboratively design the internal processes for integrating the two businesses.

Finally, once strategic decisions have been made collaboratively, the actual acts of integrating the two business can occur in the rationalize and optimize phase 104. At some point during this phase, the new business entity will be able to launch integrated business activities 108 to implement changes and capture the savings and value desired from the merger transaction in the first place.

Therefore, as demonstrated in FIG. 1, regulatory delays push back important post merger integration activities. Oftentimes, pending regulatory approval, all key preparations for the post merger integration and consolidation must be made at arms length between the two companies. Thus, strategic planning is not possible during the merger review period because sharing detailed, competitively-sensitive information is not allowed under law. Attempts to circumvent these regulatory requirements raises significant risks of illegal pre-merger coordination, which could result in potential criminal prosecution or heavy fines. This puts companies undergoing a merger into difficult situations. On the one hand, they cannot assume the merger will be approved at all, let alone without requiring certain divestitures or other changes to the terms submitted for approval. On the other hand, once the merger deal is announced, the two companies cannot proceed without making preparations for life after the deal. The question thus becomes exactly what are the best methods and mechanisms for making arms-length preparations for post-merger integration.

Many businesses turn to external consulting firms or other specialists to evaluate proposed merger and to manage the transition period for an ongoing merger. Various differing developments must take place in a relatively short time period within the merger integration period for a merger to proceed successfully, including the merging of organizations, cultures, and technologies, to eliminate redundant resources, retain the best elements from each of the original companies, and establish new elements needed by the resulting merged company. The primary advantage that an experienced consulting firm or other organization of specialists enjoys are the pooled resources and past experiences of various persons within the firm with regard to these merger related changes. While one or more of the managers of the merging companies may have experience regarding a few prior mergers, the more experienced specialists may have the benefit of working on more total mergers than the combined experiences of all the managers of the merging companies. Thus, specialist firms are able to capitalize upon their wider scope of past experience and specific knowledge regarding the lifecycle of mergers, utilizing knowledge of commonly encountered problems and pitfalls, guideposts for tracking progress, and ways to solve problems and avoid pitfalls to more efficiently direct the merging companies to meet the ultimate business objectives underlying the merger.

While specialists can be hired at the pre-deal stage (i.e., during negotiations or prior to a deal being announced publicly), typically specialists are hired into a post merger integration situation after the announcement of the deal to manage a merger after the companies have already signed contracts and announced the merger, and sometimes even after closing when various post-merger integration steps have already been taken. Most experts, however, agree that the period from the time a merger deal is announced through the first 12 to 24 months of post-merger integration is critical. Nevertheless, the time from announcement to closing of the deal, due to various regulatory reviews on the national and international levels, can be ten months or more. For certain deals, intense shareholder scrutiny can further increase the time from announcement to closure.

A business organization often desires to merge with or acquire a target company in part because of a particular desire to obtain the benefits of any series or set of assets, skills or capabilities of the target that will be relevant to their post-transition business. Yet, because of the current regulatory scheme, it is likely that significant time will pass before the acquirer business will be able to integrate the operations or structure of the target business organization to an extent sufficient to permit the transforming business organization to experience appreciable benefits from the target element.

Lead specialists typically enlist additional personnel resources from their organization, usually in the form of a team of less experienced specialists that will work under the direction of the lead specialist. These team members are often given the tasks of information gathering and sorting, such as by contacting and interviewing employees of the merging companies and obtaining, reviewing and organizing records relevant to post-merger integration activities.

Data clean rooms are tools that have been used for decades as a means to collect and synthesize data from merging entities in a secure and legally compliant environment. In the traditional sense, a data clean room is a physical, secure location that is sealed off from the merging companies' business activities. It is restricted to authorized individuals to handle sensitive data or information from the merging companies in a legally compliant manner. The use of data clean rooms therefore serves as a mechanism to reduce risks of running afoul of information sharing regulations by walling sensitive business information off from regular business activities.

Typically, authorized personnel are from a third-party (e.g., consultancies, investment banks, law firms, accounting firms) and not from either of the merging entities. The data clean room handles all legitimate data requests and analysis of proprietary information until regulatory approval is obtained and the merger is officially closed.

Traditional data clean rooms conventionally are typically used in the period where the two companies are exploring and developing the deal (i.e., before announcing the deal to the public or shareholders, and before starting the regulatory approval process). “Due diligence” reviews undertaken by bankers or attorneys use the data clean rooms primarily for rendering opinions to one of the merging regarding the accuracy of the financial statements of the other merging company. Such conventional data clean rooms therefore utilize document repositories to facilitate and track document flow during the due diligence process. They also many be maintained through regulatory review for the purpose of facilitating follow up due diligence reviews (if changes are made to the proposed deal), or to serve as an information source for regulatory reviewers. Such due diligence reviews using traditional data rooms, however, are limited in purpose and use. Under conventional practices, they are not adapted to help the merging companies during the post-merger integration process to obtain the highest value from the merger. Rather, they are intended to do just the opposite—to act as a prophylactic for regulatory compliance by walling off the sensitive business information that could be used for effective, yet impermissible, collaborative planning.

Given the information-sharing and other constraints imposed upon collaborative activities in the pre-closing phases, it is common for merging companies treat pre-deal and post-deal processes as discrete efforts. Sometimes, they even go so far as to use entirely different teams in the periods before and after the deal closing. This segregated approach results in vague accountability and general lack of leadership, unnecessary handoffs, and a disconnect between the valuation and the financial goals of the post-merger integration. In fact, this disconnect can be severe enough that post-merger integration teams tasked with managing synergy capture in the resulting merged entity could have little to no insight regarding what levels of synergy are necessary to recover the premiums that were paid in the acquisition deal. Understandably, this greatly reduces the chance that a successful deal will result.

Another factor negatively impacting the success of post-merger integration is that it is conventional for many companies to organize their post-merger integration activities on a function basis rather than on a value-added basis. While many function activities must be consolidated between the merging companies, such as, for example, merging databases, rationalizing corporate policies and procedures, reconfiguring information technology (“IT”) systems and the like, it should be clear that not all integration activities will yield equal benefits. Due to lack of experience in post-merger integration, unfortunately, companies do not always have an understanding regarding which integration activities will yield the most benefits, but nonetheless feel compelled to proceed aggressively in resolving merger integration issues. Such aggressive integration of various functions from the merging entities can actually result in destruction of value if value creation is not given appropriate consideration in integration planning. For example, if two large but regional cellular phone companies were to agree on a merger deal, there would be a very large number of business issues they would have to address outside of the regulatory review process. For example, each company presumably would have its own retail networks, billing systems, and advertising budgets that would have to be consolidated. One company could sell primarily through its own chain of corporate retail stores, while the other company utilized authorized agents and third-party resellers, like consumer electronic chains, to sell calling plan contracts and phones. Therefore, an important decision (and subsequent execution of the decision) would have to be made early in the post-merger integration period concerning which distribution channels to close and which to return or expand. Further, the two companies would likely have to address redundancies in their service offerings. For example, calling plans and associated service options from the two companies would have to be blended. Decisions such as these are important strategically as they reflect key business strategy decisions. However, such decisions could impact decisions in other areas in unforeseen ways (e.g., IT integration of supply management systems might be necessary to manage the retail stores). Thus, it is important for integration issues to be strategically resolved, with certain decisions and integration activities being addressed and undertaken before others.

As noted previously, however, speed of integration activities is very important. Merging companies cannot merely proceed at a slow and deliberate pace to make certain that activities are thoroughly planned, so strategic resolution of integration issues is more easily said than done. For an acquirer expecting to obtain $500 million in yearly cost savings from a merger transaction, a delay of a single month could reduce the net present value of the deal by $150 million or more. A seven month delay could result in nearly $1 billion in lost value, or up to $3.5 million per day. Indirect financial repercussions are also a result of such delays. Postponed business strategy implementation, diminished employee morale, and workplace or customer defections could result due to the uncertainty.

Therefore, there is a need for improved mechanisms for transforming a business organization that does not suffer from the above mentioned problems. A mechanism that provides relatively fast realization of certain target desired capabilities to the organization while allowing the benefits of a traditional merger or acquisition would be beneficial. Further, mechanisms for limiting the destruction of value during the acquisition of capabilities in such target areas would also be beneficial. Such mechanisms should enable representatives of the merging companies to use the regulatory approval and closing windows perform in-depth research and identify potential problem areas and areas of high value or high priority in the upcoming post merger integration and develop action plans for those areas with suitable remedial or corrective actions to be taken to improve the situation of the merger in those areas would be beneficial. It would also be beneficial if such mechanism also enabled the representatives to develop prospective plans for strategic decision making relating to the future of the post merger business.

### SUMMARY OF THE INVENTION

In light of the above-described and other problems attendant in post merger integration, it is an object of one or more embodiments of the present invention to provide tools and mechanisms that enable merging companies to conduct extensive planning of post merger integration activities without violating anti-collaboration restrictions during the regulatory review window.

Furthermore, it is an object of one or more embodiments of the present invention to provide architectures and processes for secure information sharing during the pre-closing period of the merger lifecycle that track information access and usage to ensure compliance with legal requirements.

Also, it is an object of one or more embodiments of the present invention to provide methods that enable a business organization to speed up realization of benefits from a merger transaction in an accelerated manner.

Finally, it is an object of one or more embodiments of the present invention to enable merger transactions to proceed as a single integrated process from the pre-deal strategy (goal assessment, target identification, valuation) phase through deal execution and into the post-integration period of its lifecycle.

In response to these and other objects and needs, the various embodiments of the present invention as hereafter described provide a secure information sharing architecture and related processes and tools for facilitating data gathering and information organizing to accelerate the post merger integration process for companies involved in a merger transaction while ensuring that information integrity is maintained in compliance with regulatory restrictions.

The present invention systemically accelerates value creation by providing an architecture that enables companies undergoing a merger or acquisition (generally, “merging business entities” or “merging entities”) to take full advantage of the typical “dead time” between deal announcement and closing, and to minimize the delay this dead time causes in jumpstarting the merger integration process. This approach according to the present invention entails the establishment of a secure information sharing architecture and the use of related processes and tools that are employed between the time of merger announcement and merger finalization (approval and closing). The architecture and related processes and tools according to the present invention reduce the time required to implement merger integration-related changes, but also substantially mitigate underlying business risks in the merger deal.

Generally, companies undergoing mergers and acquisitions utilized traditional data clean rooms to facilitate the independent due-diligence reviews performed by lawyers and bankers. Such clean rooms enabled third-party experts such as lawyers or bankers conducting due diligence reviews, to examine sensitive business information on the prospective merger partners while operating within a legal “Chinese wall” in a physically secure and isolated space.

Unlike the conventional data clean room approach, the secure information sharing architecture and related processes and tools of the present invention provide mechanisms that enable prospective business partners to initiate company comparisons and analyses and perform detailed strategic planning for the post-merger integration period during the early pre-merger period, thus significantly speeding up important post-merger integration planning timeframes. Instead of having to wait for formal approval and closing of the merger, the secure information sharing processes and tools operate effectively within the architecture of the present invention to permit detailed analyses to be performed regarding the prospective merger partners by qualified third parties, and separated from employees or executives of the merging companies, in a manner that satisfies the restrictions imposed by SEC regulations and other relevant regulations and laws.

In this regard, the present invention enables regulatory limitations to be obeyed while high-value synergy initiatives and other key post-merger integration strategies are identified and prioritized. The secure information sharing processes can include the building of detailed financial models for assessing cost synergies on a business-unit basis or even a line-item basis, creating tools for tracking synergies, assisting the legal teams with regulatory findings, setting up post-merger governance models, and administering the overall project calendar.

In the period from announcement to close, for example, the specialists utilizing the secure information sharing architecture (“SISA”) according to embodiments of the present invention are provided with secure access to sensitive and confidential business information submitted by one or more of various merging entities within a secure SISA center. This SISA center may be a physical location or virtual location, and preferably both, supported by various tools and processes according to the invention, which tools enable the submitted information to be segregated from the various merging entities. Within the SISA center, specialists that are isolated from the merging entities (until such time that interaction is appropriate) are legally permitted to review the sensitive and confidential information submitted to the SISA center by the merging entities to examine key aspects of the new entity that would result from merger of the merging entities, and model those aspects against value-capture objectives and assigned priorities. The process can address integration issues in areas ranging from retail distribution to billing processes to advertising effectiveness so long as the rules established by the secure information sharing architecture are obeyed.

In preferred embodiments of the present invention, the secure information sharing processes can define prospective metrics that will be tracked and monitored in the post merger integration phase. For example, a working premise could first be established inside the SISA center by a particular specialist that traditional post-merger integration timelines for the relevant industry of the current merger to integrate billing systems and fix related problems would be too long if customer defections ran high. This premise would thereafter be tested and analyzed prospectively to identify potential remedies before problems become serious issues in the actual post-integration efforts of the merging companies. In this regard, historic and interim data (such as updated on a daily, weekly, or monthly basis) can be utilized in testing and analyzing premises and in crafting potential remedies. Thereafter, upon closing of the deal, specialists in the SISA center can have prepared various proposals for addressing various substantive issues effecting progress and/or success of the post-merger integration.

Embodiments of the present invention reflect that the ultimate goal of post-merger integration is not necessarily expedient completion of the integration process, but also value creation (which in many cases, of course, is strongly correlated to integration timeliness). Therefore, post-merger activities are prioritized by the processes according to the present invention according to the value they will create or are expected to create. For example, if it is expected that the primary or largest value obtained from a particular merger is cross-selling opportunities to the new base of common customers, then it is important that the integration process enables a rapid transfer of customer information and the development of integrated account plans following closing of the deal.

Benefits of the merger are realized earlier into the post-merger integration period, and are not otherwise burdened with or distracted by issues relating to any ongoing merger integration efforts. Thus, utilizing the architectures according to embodiments of the present invention, it is possible for positive value creation to be realized at a relatively earlier time after post-merger or post acquisition integration activities are begun.

The SISA according to embodiments of the present invention employs a dual or mirrored organizational structure that permits two levels of post-merger planning to take place in parallel prior to final regulatory approval and closing. The first level of planning takes place outside of the SISA center and is driven by employees or contractors associated with one of the merging entities (typically, the acquiree), and proceeds in similar fashion to the conventional post-merger integration planning described above. The merging entity tasks these people with post merger integration planning tasks and/or associates them into one or more post merger integration planning teams, and these integration teams operate under the typical restraints imposed by the anti-collaboration SEC regulations. However, these integration planning tasks and “external” integration teams are mirrored within the quarantined SISA center by similar integration teams.

In this manner, while the external integration teams are prevented from conducting collaborative planning until regulatory approval is obtained and closing begins, the teams within the SISA center can operate in parallel using sensitive and confidential financial and operations information and data submitted by each merging entity and stored with a secure information repository of the SISA center. Thus, each of these parallel paths of integration activity have similar goals and work on similar integration tasks, but operate substantially independently until deal closing using different types of information so as to comply with all relevant regulatory requirements and restrictions. Therefore, upon deal approval and closing, the external and SISA center integration teams can launch directly into rapid post-merger integration activities using the plans and other outputs developed within the SISA center. Furthermore, should the deal not be approved or otherwise ultimately not proceed to closing, the information in and outputs produced within the SISA center can be destroyed to avoid any allegations of anti-competitive activities and associated liabilities.

Additionally, embodiments of the present invention utilize electronic platforms and related electronic tools for integrating communication systems of SISA management offices, which offices may represent one or more of the merging entities. In preferred embodiments of the present invention, an actual SISA center facility is remotely located from the pre-merger organization, and has a secure information facility electronic platform that is in electronic communication with one or more pre-merger organization front ends via a SISA management office platform. The SISA management office in many embodiments of the invention will deal directly with only one of the two pre-merger organizations (e.g., the acquirer company). In such typical embodiments, there can be only one pre-merger organization front end that is accessible only by leadership of the acquiree organization. However, in alternative embodiments, a pre-merger organization front end can be provided for two or more of the pre-merger entities.

Each pre-merger organization front end is in communication with a SISA management office interface, which in turn is in communication with an electronic platform of the SISA center facility. The SISA management office interface provides access and review capabilities for various members of the SISA management office so that communications into and out of the SISA center can be controlled and tracked for purposes of ensuring compliance with anti-collaborative regulations. Within the SISA center facility there is located a secure information electronic tool on the SISA center platform that has several electronic databases attached thereto. These databases can include an electronic database of confidential and sensitive electronic information and data obtained from the acquirer organization, and a separate electronic database of confidential and sensitive information and data obtained from the acquiree organization. In this manner, the information from each company would be maintained in separate databases to facilitate control of dissemination and prevent cross-contamination.

Embodiments of the present invention utilize specification requests as a mechanism for managing how the SISA creates and delivers value to the post merger integration process. Given their quarantine according to the architecture and electronic platforms as described herein, specialists that are personnel within the SISA center are freed of the constraints imposed by the SEC anti-collaboration window. The specification request mechanism carefully filters information flowing into and out of the SISA center to prevent unlawful collaboration while still permitting the specialists of the SISA personnel to review information that normally would be restricted for sharing during the anti-collaboration window and use that information for post-merger integration planning. In particular, the specification requests reflect specific requests made by the management of the merging companies for research into particular areas of post-merger integration with the goal of proactively determining how to best realize the objectives of the merger transaction before closing.

In particular preferred embodiments of the present invention, prior to quarantining of the SISA center, and therefore prior to the review of any restricted information and data, the specification requests are analyzed and specification work plans are created. Such specification requests can include data requests, where one of the merging entities has a research request that they wish to be fulfilled to facilitate or answer questions concerning business plans or decisions that they intend to implement in the rationalization and optimization phase following closing of the transaction. Such data requests, for example, will provide specific details, including time periods in questions, sample charts, etc. Legal review is conducted of all data requests and synthesized such that only “clean” data is utilized within the SISA center. In practice, the work plans should identify the particular decisions and/or issues that need to be resolved first.

In this regard, a first aspect of the present invention relates to a computing network architecture adapted to facilitate a SISA for performing post-merger integration planning activities using collaborative information and data collected from one or more merging entities wherein the planning activities occur during a regulatory review period. The network architecture includes a secure information facility electronic network located within a SISA center facility. The secure information facility network includes a request management tool, one or more information repository databases containing the collaborative information, and a first communications tracking database. Also, the request management tool is adapted to automatically populate the first request communications database. The network further includes a SISA management office electronic network located external to the SISA center. The SISA management office electronic network is in secure electronic communication with the secure information facility electronic network via an interface to the request management tool and the interface automatically populates a second request communications database. The SISA management office electronic network further has a SISA management office front end to permit management office personnel to review, create, and process specification requests for consideration by specialists quarantined within the SISA center facility in light of the collaborative information. Finally, the network includes a pre-merger organization front end in remote electronic communication with the interface. This pre-merger organization front end is in local communication with a third request communications database. The request communication databases catalog the transmission of information into and out of the SISA center facility in the form of specification requests and clarification requests.

Additionally, a second aspect of the present invention relates to a secure SISA for performing post-merger integration planning activities using collaborative information and data collected from one or more merging entities wherein the planning activities occur during a regulatory review period. The SISA includes a SISA center secured from the merging entities and containing a secure information repository containing the collaborative information. Communications into and out of the SISA center are monitored and controlled by an electronic request management tool and tracked in a first communications tracking database that is automatically populated by the request management tool. The SISA center has personnel that includes business specialists assigned to one or more integration teams for the planning activities. The SISA also includes a SISA management office external to the SISA center and in communication with the SISA center via the request management tool. The SISA management office uses a remote interface to the request management tool to communicate with the SISA center and this interface is adapted to automatically populate a second request communications database. The interface permits the personnel of SISA management office to review, create, and process specification requests for consideration by specialists quarantined within the SISA center in light of the collaborative information. Further, the SISA includes one or more external integration teams managed by one or more of the merging entities and corresponding to one or more of the integration teams within the SISA center. The external integration teams use a second front end application to communicate with the SISA center via the specialists in SISA center without violating anti-collaborative regulations. Request communication databases located in the SISA center, in the SISA management office, and in each pre-merger entity catalog the transmission of information into and out of the SISA center facility in the form of specification requests and clarification requests.

Further, a third aspect of the invention includes a secure information sharing process for performing post-merger integration planning activities using collaborative information and data collected from one or more merging entities wherein the planning activities occur during a regulatory review period. The process comprises establishing a secure information sharing architecture (“SISA”). The architecture comprises a secure information facility electronic network located within a SISA center facility, where the secure information facility network includes a request management tool, one or more information repository databases containing the collaborative information, and a first communications tracking database. The request management tool is adapted to automatically populate the first request communications database. The process continues with establishing a SISA management office electronic network located external to the SISA center. The SISA management office electronic network is established to be in secure electronic communication with the secure information facility electronic network via an interface to the request management tool. The interface automatically populates a second request communications database. The SISA management office electronic network further has a SISA management office front end to permit management office personnel to review, create, and process specification requests for consideration by specialists quarantined within the SISA center facility in light of the collaborative information. Further, the process includes receiving the specification requests from a pre-merger organization front end in remote electronic communication with the interface. The pre-merger organization front end is in local communication with a third request communications database. Additionally, the process includes cataloging the transmission of information into and out of the SISA center facility in the request communication databases in the form of the specification requests.

The various features of different embodiments and aspects of the invention having thus been described, preferred embodiments thereof will hereafter be described in detail with respect to several drawings.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 is a schematic diagram depicting an example of a typical timeline of the post-deal phases of a merger or acquisition transaction lifecycle;

FIG. 2 is a schematic diagram depicting one embodiment of a secure information sharing architecture according to the present invention;

FIG. 3a through FIG. 3d collectively depict in flow diagram form a secure information sharing process that establishes and then utilizes a secure information handling architecture during the pre-closing phases of a merger or acquisition integration to accelerate the launching of integrated business activities according to one preferred embodiment of the present invention;

FIG. 4 is a logic schematic diagram depicting the flow of information and communications between various entities according to an secure information sharing process according to one embodiment of the present invention;

FIG. 5 is a schematic diagram of a network for technically implementing a secure information sharing architecture according to one preferred embodiment of the present invention;

FIG. 6 is a depiction of a specification request work plan form for managing tasks involved with specification requests according to certain preferred embodiments of the present invention; and

FIG. 7 through FIG. 9 depict sample deliverables that may be prepared during the quarantine of the SISA center for each specification request according to preferred embodiments of the present invention.

### DETAILED DESCRIPTION OF THE PREFERRED EMBODIMENTS

The secure information architecture and related process and tools according to the present invention are able to facilitate and serve all the functions of traditional data clean rooms, but furthermore enables the merging companies to benefit from the performance of high quality, informed baselining analysis during the regulatory review period, anticipation of analysis priorities based on value drivers and relative complexity, the ability to support unanticipated analysis requests from the merging companies, and otherwise enhances readiness for “Day One” (the first day following closing of the merger transaction).

The personnel that establish, support, and primarily utilize the secure information sharing architecture (“SISA”) of the present invention are, of course, an important component to the value of the integration assistance provided by embodiments of the present invention. The personnel are typically financial consultants and other subject matter specialists (collectively, “specialists”), and, as such, these specialists should have the ability to organize and run complex processes in a short period of time and seamlessly using basic technologies and facilities, and deep knowledge of the merging companies obtained through conducting operational projects across all the functions with a role in synergistic value creation. Further, the personnel operating the SISA center (as hereinafter described) should include subject matter specialists in all functional areas, including cross-industry benchmarks and current leading practices. Finally, the SISA personnel should also have persons in leadership positions that have significant experience to provide sound business judgment regarding value priorities, regulatory and legal pressures, cultural sensitivity and executive presence.

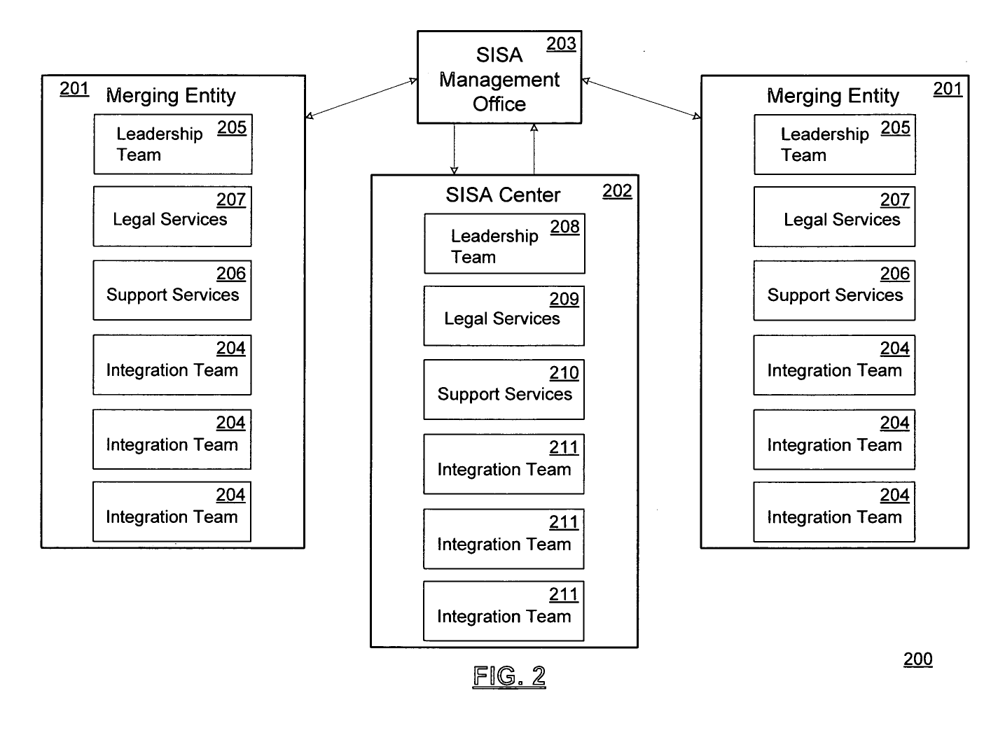

A SISA 200 according to one preferred embodiment of the present invention is depicted in FIG. 2. As shown in FIG. 2, two merging entities 201 are logically connected to a SISA center 202 via a SISA management office 203 during the period of post-merger integration activity preceding closing of the deal (i.e., before legal limitations on information sharing are formally lifted). The SISA management office 203 is responsible for the management of the day-to-day activities of the SISA architecture 200, and comprises a management team that includes include candidates selected from the management and/or employees of one of the original merging entities 201 (usually the business organization that is the acquiree), or candidates can be provided by a specialist or specialist organization (such as a consulting firm or service provider knowledgeable in areas of particular relevance to the merger transaction in question, including those having industry expertise). The SISA management office 203 also preferably includes its own staff of attorneys to provide on-demand legal advice concerning practices for segregating information flows between the merging companies and controlling the flow of information into and out of the secure information repository of the SISA center as described below.

The secure information sharing architecture 200 as depicted in the embodiment of FIG. 2 employs a dual or mirrored organizational structure that permits two levels of post-merger planning to take place on two parallel paths. The first level of planning approximates the pre-closing planning that conventionally takes place for post merger integrations wherein the parties are prevented from conducting collaborative planning until regulatory approval is obtained and closing begins. In this regard, a team of employees from a given merging entity, or consultants hired by that entity, are tasked with independently performing research using only publicly available data regarding the other merging entities to develop business cases, projections, and proposed strategic integration plans. Thus, this first level of planning involves the use of one or more traditional integration planning teams 204, directed and supported by the corporate leadership 205, legal teams 207 and other support services staff 206 of that merging entity, to perform preparatory analyses in planning for post-merger upcoming integration activities.

However, the secure information sharing architecture 200 of embodiments of the present invention further enables collaborative planning to take place in parallel while still complying with all relevant regulatory requirements and restrictions. This collaborative planning is performed by a team of trained and skilled third party specialists that have access to a secure information repository containing sensitive financial and operations data from all of the companies involved in the merger transaction. The secure information repository is maintained and contained within the SISA center 202, and made available to the team of specialists that are selected as SISA center personnel. The SISA center personnel are tasked with similar goals and projects as the specialists on the outside, but operate independently from those specialists up until the date that regulatory approval is obtained and closing occurs (thus lifting all restrictions on collaboration). These specialists are secured within the SISA center 202 formed by the architecture 200 and are in this manner completely segregated from the other “traditional” integration teams 204 of the merging entities 201. In this manner, the personnel in the SISA center 203 can operate independently from the traditional integration teams 204 outside of the SISA center 203 and exploit information that otherwise would be restricted from post-merger planning use until after regulatory approval and closing. Upon closing of the merger, each integration team 211 of the SISA center 202 is preferably allowed to meet with corresponding ones of the integration teams 204 of each of the merging entities 201 to communicate the data compiled by, conclusions drawn by, and proposed integration solutions crafted within the SISA center.

The overall leadership of the SISA, including both the leadership 208 of the SISA center 203 and managers of the SISA management office 202, preferably includes executive-level resources from at least one of the merging companies, and highly qualified lead specialist that is familiar with merger integration planning and operation of the SISA 200. This leadership also most preferably forms a leadership committee that sets and oversees the execution of the overall work plan, acts as key liaison with key stakeholders and reviews and gives approval for key decisions.

The SISA management office is lead by an integration manager that is a specialist that operates on an executive level with regard to running the day to day operations of the SISA, by setting the scope and objectives of the SISA management office, ensuring that SISA processes meet the expectations of the leadership team, and monitoring the integrity of the SISA.

The SISA management office 203 is a dedicated team of program and project managers whose sole focus is facilitating merger integration activities. As will be readily appreciated by one skilled in the art, the SISA management office 203 serves as a communication gateway between the SISA center 202 and the outside world, including integration teams 204 working for or within either of the merging entities 201. As described in further detail below, the SISA management office 203 takes the lead in most logistical and coordinating functions, including mobilizing and coordinating post merger integration activity, tracking progress and results on both the planning side and the execution side of closing, identifying issues and setting agendas.

The SISA management office 203 preferably includes a leadership steering committee that is tasked with establishing merger objectives, designing overall process goals and restrictions, making decisions and/or approvals and resolving conflicts, assigning team leaders to particular functional tasks, and generally creating various demands for research and outputs (such as in the form of formal “specification requests”) by the specialists within the SISA center 202.

Core team members comprising the SISA center personnel include specialists (financial, managerial, etc.) at various levels of expertise and seniority with project management experience and client subject matter experts that are used to form integration teams 211 within the SISA center. SISA personnel also includes necessary support staff 210 and legal resources 209 for helping to develop, facilitate, and perform the functions of the SISA center 203. The integration teams 211, for example, can utilize financial management specialists to examine financial controls and monitor and analyze findings concerning merger integration synergies in order to craft recommendations for management of the merging entities or detailed integration plans (for delivery upon closing).

Program management technology resources are preferably included in the support services staff 210, and can include a manager level specialist with IT expertise who is tasked with managing personnel for and overseeing the tasks of developing, installing and supporting the technical infrastructure to support the SISA 200, including scheduling and reporting tools and related hardware, productivity and communication software, and business applications.

The various integration teams 211 within the SISA center 202, like integration teams 204, are comprised of various specialists tasked with handling specification requests from the SISA management office 203 and their day to day responsibilities include identifying issues, collecting data, and performing analyses to make recommendations to the steering committee. Upon closing, the various external integration teams receive detailed reports from the SISA center and work on reviewing and implementing the recommendations of those reports in the early post-merger integration phase.

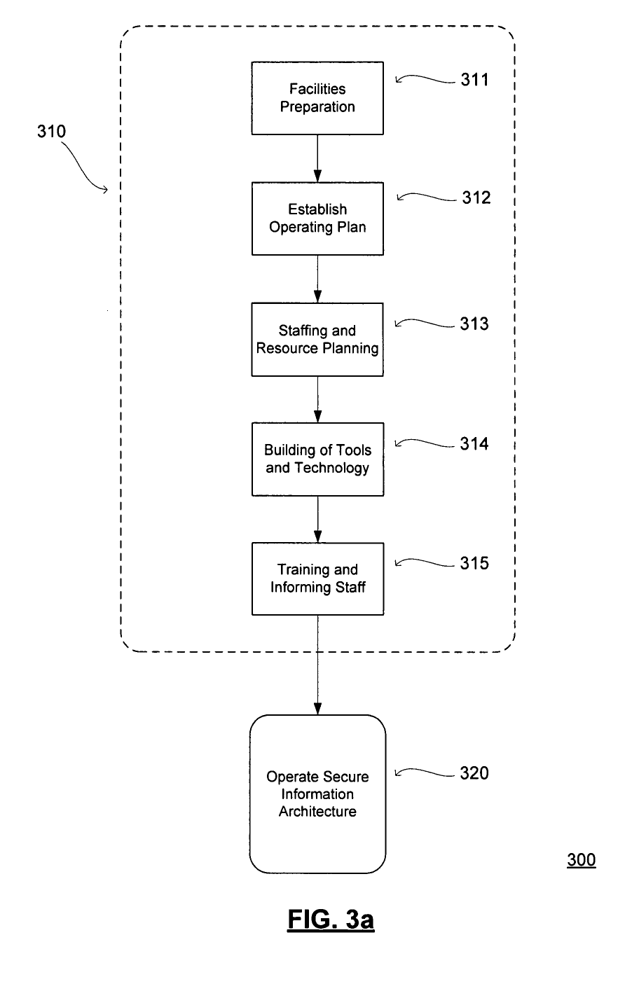

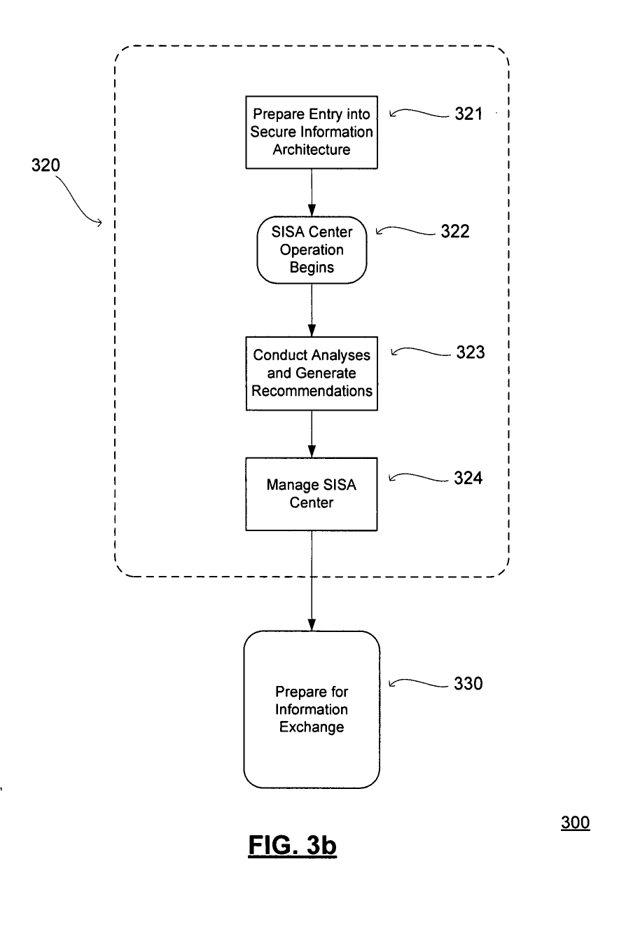

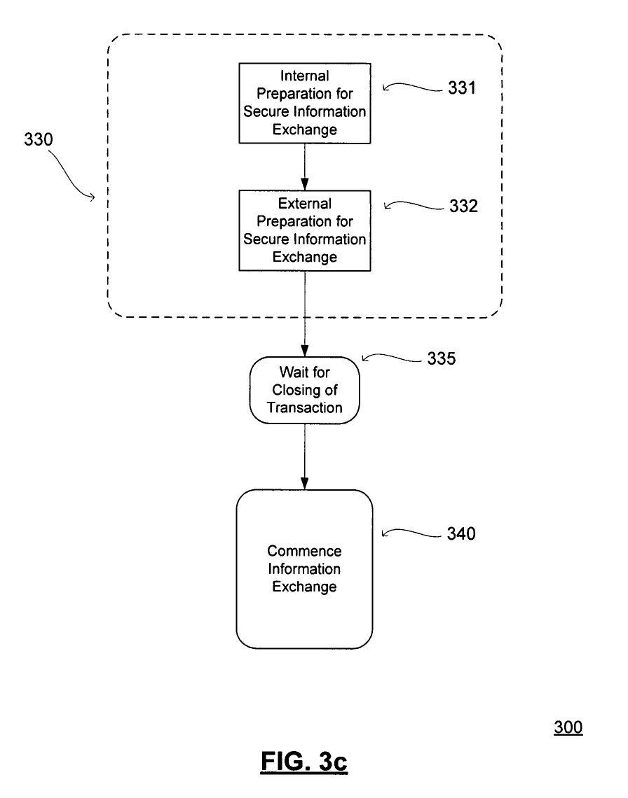

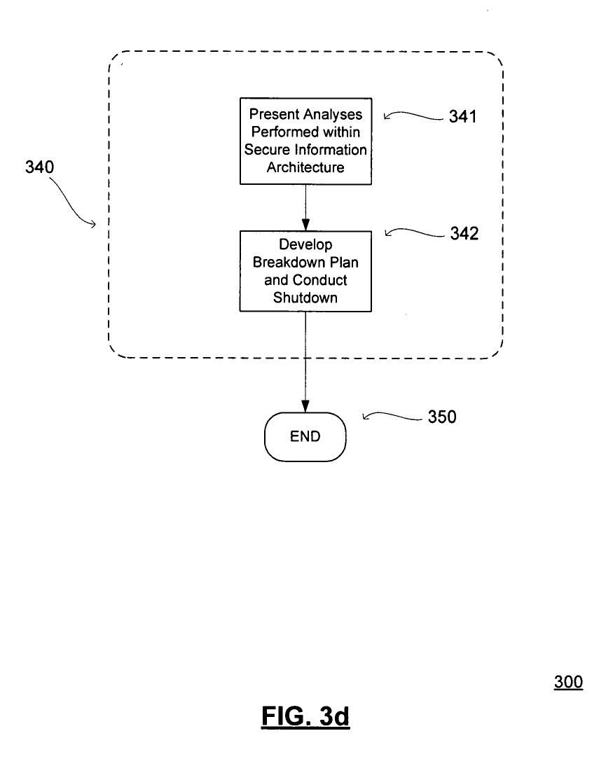

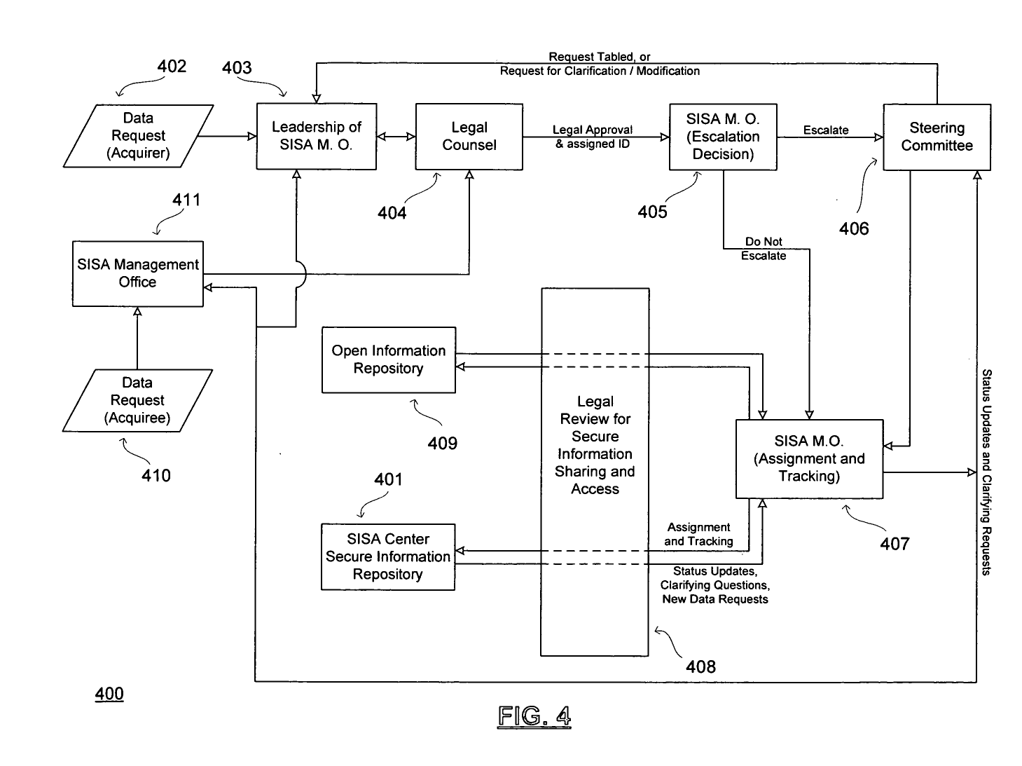

While the architecture 200 of FIG. 2 is depicted as having two merging entities 201, the above description of the operation of this embodiment of the present invention can be readily adapted by one skilled in the art to a situation where three or more business organizations are involved in the merger or acquisition deal and are desired to receive benefits of the SISA center. Further, while each merging entity 201 is shown as having integration teams 204 that operate independently from the teams of the other entity or integration teams 211 within the SISA center 202, it should likewise be understood that it is not required for all merging entities to employ the same number of integration teams, or even for more than one merging entity 201 to employ any integration teams 204 at all. However, as will be made clear below, it would be advantageous and thus preferred that the SISA 200 be established such that each integration team 211 in the SISA center 202 corresponds to at least one integration team 204 run by or on behalf of at least one of the merging entities 201. The various configurations of the SISA 200 will be more readily understood after consideration of FIG. 3a through FIG. 4, as described hereafter.

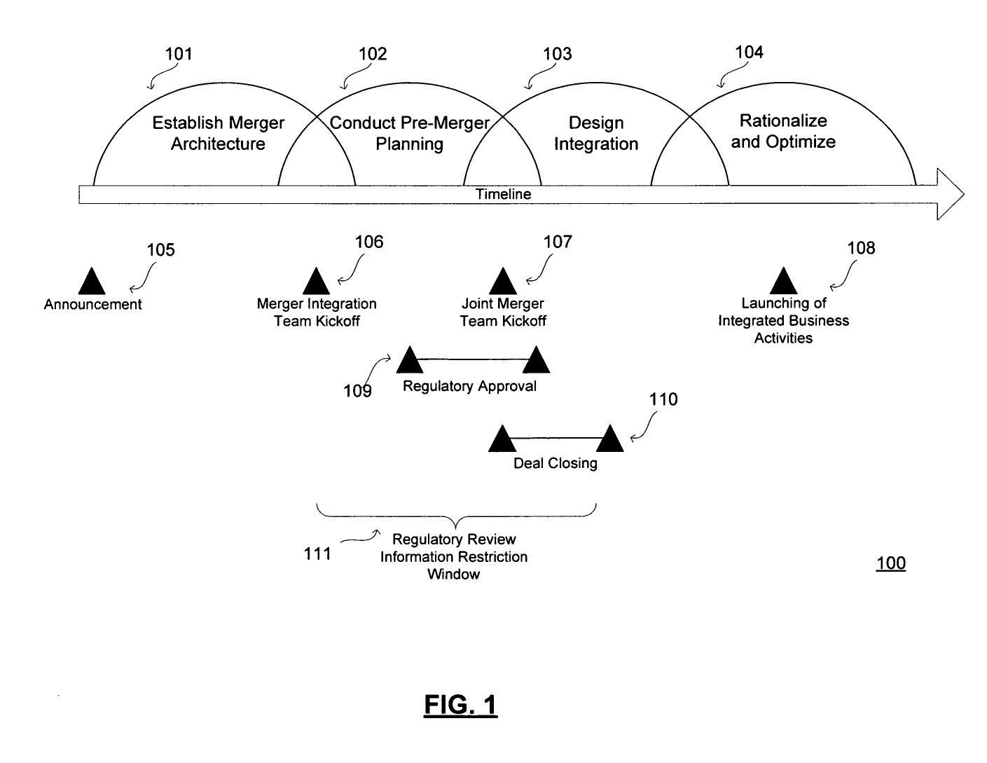

FIG. 3a through FIG. 3d collectively depict in flow diagram form a secure information sharing process 400 that establishes and then utilizes a SISA during the pre-closing phases of a merger or acquisition integration to accelerate the launching of integrated business activities according to one preferred embodiment of the present invention. Process 300 begins during a period before the merger or acquisition deal is closed and proceeds within the regulatory review information restriction window (as depicted and described above with respect to FIG. 1). Preferably, information sharing process 300 is initiated at an early time following announcement of the deal such that logistical preparations necessary for secure information sharing to commence can be made in accordance with the architecture of the invention.

As depicted in FIG. 3a through FIG. 3d, the process 300 can be conceptualized as comprising four consecutive phases. The mobilization phase 310, the first phase that begins the process 300, is depicted in FIG. 3a in detail as comprising five constituent steps. The mobilization phase 310 and process 300 both begin with the preparation of facilities at step 311. This step entails the design and build-out the physical site and facilities that will house a secure information repository and associated personnel, which facilities are termed herein a “SISA center” and personnel termed herein as comprising the “SISA personnel” or “SISA team.” During this step, it is important to ensure that the center is compliant with overall security and legal requirements. By the end of step 311, a physical site selection should be made, along with a business case presented supporting the selection of the specific location. Typically, it is best that the selected site be neutral with regard to merging companies, however convenience usually dictates that the location is in a town or city near the acquirer's headquarter (to facilitate post-closing open information sharing) but in a separate location.

Additionally, leases or contracts should be executed, and the floor plan, layout and technical infrastructure (number of phone lines, LAN connections, and other technical considerations) of the facility should be established at least roughly. The facility and floor plan for the SISA center would, for example, maximize functional team's efficiencies by clustering appropriate teams together. Finally and importantly, the security plan for the chosen facility should be established. This plan will create secure data and security storage areas with attendant security protocols.

Next, step 312 entails the establishing of the operating plan for the SISA center and its personnel. This step therefore develops the overall processes, policies and guidelines for operating the SISA center, which drives the build-out of the actual SISA center facilities and the supporting security tools and technology platform. The results of step 312 are reflected mainly in official guidelines and policies that will govern the use of information and data within the center and how information flow is controlled into and out of the SISA center. These guidelines describe protocols for ingraining the significant legal oversight and approvals needed to monitor the information flows. These protocols should address how data will move in and out of the SISA center's secure information repository, and address how exception cases will be handled including clarifying questions.

Typically, step 312 will also include the establishment, in conjunction with the merging company (or companies) that have requested utilization of the SISA and that company's legal counsel the security levels required for the SISA center. The protocols and security clearances work together to identify the different scenarios by which information might need to go into or out of the SISA center and stipulate documentation and tracking process flows that are designed to limit chances for a legal breach. For example, it could be established that SISA team members cannot bring briefcases or laptops into the SISA center facilities, and that all computers except a select few in the SISA center facilities will configured to prevent the copying of files to portable writable storage (floppy disk, CD-R/CD-RW and DVD-R/DVD-RW, thumb drive, or the like).

Finally, it is preferable that the operating plan established in step 312 incorporate the presence of legal counsel inside the SISA center facilities as a full time part of the SISA team, enabling this SISA “in-house” counsel to communicate with legal counsel on the outside to facilitate communications into and out of the SISA center.

Vague definitions of success should be avoided at this step with the goal of establishing a post merger process and plan that have clear focus on measurable areas of value creation including metrics. Post-merger integration goals should be set and made easily understandable and financially driven. Any synergy-related targets and goals should be reflected inherently within these targets and goals in a manner that it can be measured with respect to the ongoing operative budgets of the post-merger business. Non-financial strategic definitions are considered non-preferred unless they a financial basis and can be clearly translated into financial outcomes (e.g., incremental cash flow returned in the form of increased shareholder value).

Step 313 entails the planning for personnel and staffing of the SISA center and the non-personnel resources that the center will require. This step therefore requires lead specialists, who will ultimately serve leadership roles inside of the SISA center during operation, to identify the appropriate personnel and other resources for the SISA center and establish appropriate plans for rolling resources into the center.

A typical staffing plan will call for a leadership team to be established, with an identification of key persons that should serve on the leadership team, and will also provide a high-level organization chart. Key staffing terms and accompanying employment contracts (e.g., confidentiality agreements) should also be prepared during this step.

The staffing plan preferably also identifies personnel that is necessary to operate the SISA center on the inside as well as to support the SISA center from the outside via the SISA management office. For example, specialists should be enlisted according to their individual experience and skill set to ensure that the knowledge base in the SISA center represents all companies involved in the merger. The specialists that will serve on staff in the SISA center should be identified as early as possible such that they can begin to gather publicly available knowledge as much as possible while on the “outside” to gain greatest clarity regarding requests before communications become scrutinized and/or minimized in accord with the SISA procedures.

Also, it is preferable that not only does the SISA center personnel include inside attorneys, but that those attorneys include some that are experienced anti-trust legal counsel. Most preferably, such anti-trust legal counsel should also be present on the support teams outside of the SISA center to facilitate clarifications and legal concerns.

Finally, the resource plan established in step 313 should identify appropriate resources by area and provide an appropriate roll-on schedule those resources. For example, moving of resources into the SISA center should be staggered as appropriate, with, for example, furniture being delivered before office supplies and communications equipment to eliminate unnecessary efforts in initial set up.

Step 314 as depicted in FIG. 3a entails the building of tools and technology necessary to enable the SISA and support the SISA center. During step 314, experienced IT personnel are employed to develop and install a technology infrastructure to holistically support the SISA center and integrate the center with activities of the outside support teams that are working directly with one or more of the merging companies.

Deliverables from step 314 include detailed statements of technology requirements for the clean room and a technical platform blueprint to support the SISA communications and information flows. At this step, any necessary software tools should be identified and either obtained, or designed and implemented. Additionally, templates should be designed for communications into and out of the SISA center.

With regard to the SISA technical platform, it is important that it include clearly defined security requirements and constraints for the various communication and information applications and support the definition of roles and responsibilities of users in relationship to secure information handling processes as described in further detail herein.

Finally, it is also important that the SISA technical platform be up and operational in advance of the SISA center receiving the initial information deposit from the merging companies and the information quarantine starting. Thus, all installation and testing activities for the SISA technical platform should be scheduled to occur significantly in advance of the targeted quarantine date.

The mobilization phase 310 finally concludes at step 315 with the formal training, informing, and orienting of the personnel that will staff the various aspects of the SISA architecture, including those that will operate within the quarantine environment of the SISA center and those that will support the SISA from the outside via the SISA management office. Within step 315, particular care is taken to ensure that key personnel are trained appropriately to ensure compliance with anti-trust and regulatory requirements.

One suitable way in which to perform training and informing step 315 could be to implement a training plan that details the various requirements for different groups of personnel trainees and, in particular, identifies how their role integrates into the overall SISA, from information flow tracking to logistics.

All training materials used in this step should preferably first obtain legal approval. Anti-trust lawyers should be heavily involved in content development and professional learning specialists utilized in the actual driving of the delivery for optimum effect.

Following the training and informing of staff at step 315, the mobilization phase 310 of process 300 is complete and the operation of the SISA phase 320 begins. The various steps comprising phase 320 are depicted in detail in FIG. 3b.

Referring now to FIG. 3b, it can be seen that the operation phase 310 begins with the preparation for execution of the SISA and entry into the SISA center at step 321. At this time, the SISA personnel begin to develop the work plans and requests for the specifications that will be completed in the SISA center.

These specifications are the primary mechanism by which the SISA creates and delivers value to the post merger integration process. freed of the constraints imposed by the SEC anti-collaboration window by the SISA, the specialists that are SISA center personnel are permitted to review information that normally would be restricted for sharing during the anti-collaboration window. The specifications reflect specific requests made by the management of the merging companies for research into how to best realize the objectives of the merger transaction.

Prior to quarantining of the SISA center, and therefore prior to the review of any restricted information and data, the specification requests are analyzed and specification work plans are created.

Such specification requests can include data requests, where one of the merging entities has a research request that they wish to be fulfilled to facilitate or answer questions concerning business plans or decisions that they intend to implement in the rationalization and optimization phase following closing of the transaction.

Such data requests, for example, will provide specific details, including time periods in questions, sample charts, etc. Legal review is conducted of all data requests and synthesized such that only “clean” data is utilized within the SISA center. In practice, the work plans should identify the particular decisions and/or issues that need to be resolved first.

Preferably, a flexible administrative staff is maintained to assist in peak times and assign point people for specific divisions to reduce number of interfaces.

At the point in time 322 represented in phase 320, the SISA center is ready for operation, and the quarantining of information and data within the SISA secure information repository and the SISA personnel in accord with the establishes SISA architecture begins.

Phase 320 thereafter continues at step 323 with the conducting of analyses and generation of recommendations to satisfy the specification requests according to the work plans. In particular, at step 323, the SISA personnel will collect and review data from both companies and complete the specification requests in independent fashion from influence of the merging companies until such time as the merger transaction closing is completed. Step 323 therefore represents the time period wherein the SISA established in the mobilization phase 310 begins to be utilized and value creation begins.

In the time period of step 323, the specialists who were selected to be SISA center personnel are freed to review the information and data in the secure information repository for the completion of data and specification requests and use that information to make strategic judgments and forecasts and prepare deliverables for review by managers of the resulting post-merger entity once appropriate regulatory approvals have been obtained, closing has proceeded, and all legal prohibitions on sharing and utilization of the information between the merging companies has been lifted.

Deliverables prepared during this time period can include project deliverable packs for each specification request, which can provide functional summaries, detailed financial projections and costs analyses, and executive insights and memoranda.

At this point, communication with support personnel and management of the merging companies outside by SISA center personnel is greatly restricted and allowed only via the SISA management office and only in so far as those communications meet stringent criteria. These criteria are monitored and enforced in large part by in-house and outside legal counsel and electronic information management tools to implement the desired and necessary security processes. An example of such a security process that can be utilized during quarantining of the SISA center is the secure information handling process described below with respect to FIG. 4.

Communication by the SISA center personnel with outside entities at this time can be made when necessary so long as information integrity within the secure information repository is maintained. For example, sample deliverables that are not specific to the industry of the project can be used to inform the outside generically of the format of deliverables that should be expected once the quarantine is lifted and can be used in the interim in making analogies for project discussions. Similarly, from time to time it will be necessary for specialists who are SISA personnel to request guidance regarding the specification requests. In this regard, clarifying questions, upon getting approval following legal review, can be sent out of the SISA center to the originator of the specification request (e.g., a management team for one of the merging entities) to resolve ambiguities.

Phase 320 thereafter continues with step 324 wherein the managing of the SISA center takes place. Understandably, steps 323 and 324 are complementary in nature and their underlying functions and tasks are performed according to the SISA at the same time. Step 324 represents the various administrative steps that occur while the SISA center is operating in its quarantined state a securely handling data and information requests according to the SISA. The tasks represented here include managing the progress of SISA center in meeting the specification requests submitted into the SISA, and monitors personnel activities and communications to ensure that they stay on track to complete specification requests and related projects on time before the SISA center quarantine is lifted once the merger transaction has been approved and closes.

During this step, the SISA center utilizes various tools to monitor productivity, schedules and information flows, which tools provide, for example, issue logs, regular status reports, mechanisms for creating, clearing legally, submitting, and tracking clarifying questions, and new specification/data requests and request change logs for communications coming into the SISA center from outside support staff and management of the merging companies. The outside support staff and team will manage all the process and reporting that are external to the SISA center, with all contacts flowing into and out of the SISA center passing through at least one level of legal review (either by inside or outside counsel, and preferably both).

As will be readily appreciated by one skilled in the art, the operating phase 320 of process 300 will of course take place for as long as the SISA center is operating in its quarantined state. SISA center personnel will be given updated timelines and reports concerning the regulatory review process and expected closing timelines as they occur so that planned progress for the completion of various specification requests can be updated as necessary. Upon completion of the operations phase 320, the information exchange preparations phase 330 begins. The constituent steps of phase 330 are depicted in detail in FIG. 3c.

Referring now to FIG. 3c, the first step 331 of the information exchange preparations phase 330 is depicted as comprising the internal preparation within the SISA center by SISA personnel for the actual exchanging the of information and analyses performed in the SISA center during operations phase 320. In particular, this step entails preparation by the SISA personnel for releasing it's analysis and recommendations, and, in this period of process 300, the SISA center will set expectations of what the post merger integration teams working with the SISA management office will receive.

For example, the SISA center can prepare memoranda clarifying what deliverables are to be expected, with detailed list of reports and projects. This facilitates communication between the clean room and the outside to ensure that both outside companies know what is coming out of the clean room. Additionally, various administrative tasks will be undertaken within the SISA center at this time, including preparation of the contents of the secure information repository for return to the merging entities and/or storage, such as by preparing shipping labels, packing lists, and the like. Additionally, archiving of electronic data could be begun.

Next, at step 332 (or concurrently with step 331), the SISA management office and various post merger integration teams outside the SISA center will coordinate how the analyses and recommendations prepared by the SISA personnel will be delivered upon closing of the merger transaction. The post merger integration team will, for example, coordinate various read out sessions that will take place, and will allocate delivery of various SISA personnel deliverables (specifications) to the appropriate integration teams and team members to minimize delays caused in handoffs.

Phase 330 is completed when the tasks comprising steps 331 and 332 are completed. At this time, process 300 waits at time period 335 to enter the final phase, the information exchange commencement phase 340, which phase will not begin until the date of closing.

Upon the day of closing, the information exchange commencement phase 340 of process 300 initiates as depicted in FIG. 3d with step 341. In this first step, the SISA center personnel's specialists present the results of the various analyses performed according to the specifications while within the SISA center. At this time, executive and functional team readout sessions occur in coordinated fashion. In particular, this information exchange can be arranged in conventional manners, with executive-level overview meetings, functional integration team overview sessions, functional team detailed discussion breakout sessions, and the like.

Preferably, high priority project readout sessions are scheduled to take place near the beginning information exchange process, with sufficient time being scheduled for high value participants to read reports and review data in sufficient depth prior to detailed meetings.

Finally, at step 342 a breakdown plan is developed and shutdown of the SISA and SISA center is conducted. A complete breakdown plan is used to facilitate the transfer of SISA center data and files to appropriate locations and persons, and to dispose of and/or redistribute the SISA center's technology resources as appropriate. For example, during this step a list of all vendors, including an inventory of what is on lease from them, terms of payment, etc., could be compiled and followed.

Understandably, specialists that were members of the SISA center personnel are preferably absorbed into functional teams of specialists within the merging entities or resulting entity that are in charge of implementing the actual post merger integration plans and projects developed as a result of the SISA center activities. This absorption facilitate handoffs and further speeds up the post merger integration progress. Process 300 thereafter ends at time 350.

Turning now to FIG. 4, there is schematically depicted various information flows through a secure information handling process 400 according to one preferred embodiment of the present invention. Process 400 reflects how the SISA addresses how data and information requests move into and out of the SISA center, and how exception cases (such as where legal cautions are raised or where clarifying questions are asked) will be handled. In particular, in FIG. 4 there is depicted a secure information repository 401, which repository would be the actual secure information and data archives contained in a SISA center according to embodiments of the invention. Access to the data contained in the information repository 401 of the SISA center is tightly controlled according the established SISA procedures, which procedures in part include the secure information handling process 400. As shown in FIG. 4, information flows between the various different entities communicate data and requests with one another concerning the merger transaction. These communications can, for example, concern requests from one of the merging companies, or from the SISA management office, for information stored in the secure information repository 401 or, alternatively, in an open information repository 409 (which contains information capable of being freely shared among all parties to the merger transaction). The depicted communications and information flows also support new specification requests originating from the merging companies (acquirer or acquiree) or the SISA management office while the SISA center is operating in its secure, quarantined state (i.e., prior to closing).

For example, FIG. 4 depicts new data and specification requests coming from the acquirer merging entity at 420, which requests are then communicated directly to the leadership of the SISA management office at 403. The leadership 403 reviews and processes the request with the help of legal counsel 404 (outside of the SISA center), which legal counsel then, if appropriate, grants legal approval to the request, assigns it a request ID, and forwards the approved request to appropriate personnel 405 in the SISA management office that are tasked with making an escalation decision regarding the request.

FIG. 4 also depicts the parallel situation where depicts new data and specification requests originate from the acquiree merging entity at 410. As the acquiree is required to maintain arms length transactions with organizations of the acquirer merging entity, which include the SISA management office (which typically are contractors of the acquirer), such requests 410 are communicated directly to legal counsel 404 by the SISA management office at 411 without the input or review by the leadership of the SISA management office at 403. The legal counsel 404 then reviews the request. Approved requests are assigned request IDs in similar fashion to data requests 402 and then likewise sent for an escalation decision.

The escalation decision undertaken by personnel 405 determines whether the communicated request is of the standard type that should be transmitted directly to the SISA center, or whether the request in question concerns a strategically important issue that should be directed to the steering committee 406. This decision would not be performed on an ad hoc basis, but rather would be made according to detailed predetermined criteria established prior to quarantining of the SISA center. If the request triggers and number of escalation flags according to the predetermined criteria, the request is escalated directly to the steering committee at 406. If no escalation flags are triggered, then the request is not escalated and is sent directly to the SISA management office personnel or group in charge of assignments and requests tracking in the SISA center, as denoted at 407.

This SISA management office tracking group 407 then routes any communications through the SISA center's internal legal review team 408, which team makes the determination whether to route the requests into the SISA center (which handles the request utilizing information and data contained in the secure information repository 401) or the determination that the request can be handled utilizing only information from the open information repository 409. Understandably, the legal review team 408 also can refuse to honor any assignments or requests for information that it determines will violate the security rules of the SISA.

As indicated in FIG. 4, there is significant feedback that is permitted to take place according to the secure information handling process 400. While the SISA management office tracking group transmits assignments and requests into the SISA center, the SISA center also transmits information back out through legal review 408, including status updates (such that SISA management office group 407 can update progress reports and other tracking information), clarifying questions concerning the scope of the request/specification, and requests for new data to be submitted by the merging entities into the secure information repository 401.

As represented by the information flows depicted in FIG. 4, the status updates and various requests are then routed by the SISA management office assignment and tracking group 407 to various destinations as necessary, including to the steering committee 406, to the SISA management office 411, or to the SISA management office leadership 403.

One of ordinary skill in the art should appreciate that the information flows and communications provided in FIG. 4 are intended to conceptually depict how various persons and groups communicate securely utilizing the SISA according to embodiments of the invention. Thus, it should be understood that the process 400 depicted is only one such process and as presented depicts only major information flow between the primary groups that are typically necessarily involved in requests concerning the sensitive business information secured in the SISA center.

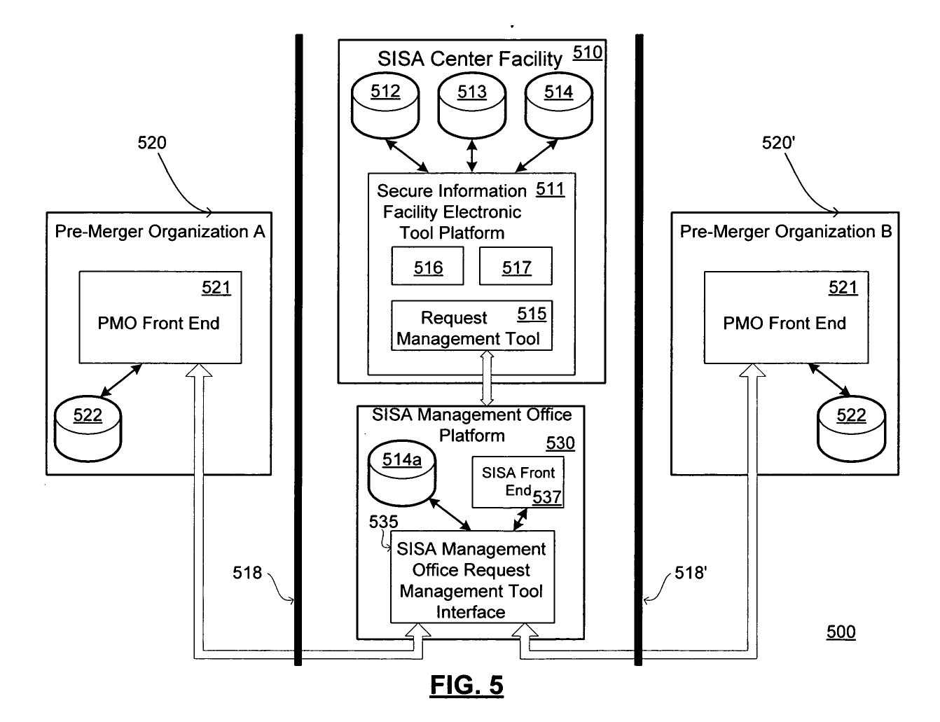

A suitable electronic platform 500 and related tools for integrating communication systems of SISA management office, which offices may represent one or more of the merging entities, and the SISA center is depicted schematically in FIG. 5. FIG. 5 depicts the common case of a two company merger or acquisition, involving an acquirer company 520 (pre-merger organization A) and an acquiree company 520′ (pre-merger organization B). The actual SISA center facility 510 is depicted in FIG. 5 as being remotely located from both pre-merger organizations 520 and 520′.

Within the SISA center facility 510 there is located a request management tool 515 on the SISA center platform 511 that has several electronic databases attached thereto. These databases can include an electronic database of confidential and sensitive electronic information and data obtained from the acquirer organization (database 512), and a separate electronic database of similar confidential and sensitive information and data obtained from the acquiree organization (database 513). In this manner, the information from each company would be maintained in separate databases to facilitate control of dissemination and prevent cross-contamination. In many circumstances, it is expected that the SISA will be deployed at the request and expense of the organization playing the role of the acquirer company in the merger transaction. Thus, the SISA management office will typically deal directly with only one of the two pre-merger organizations, namely the acquirer company. In the example platform 500 depicted in FIG. 5, however, there are pre-merger organization (“PMO”) front ends 521 for each of the pre-merger organizations 520 and 520′.

Each PMO front end 521 is in communication with a SISA management office computing platform 530 which includes a request management tool interface 535 that in turn is in communication with an electronic platform 511 of the SISA center facility 510. PMO front end 521 may be a computer program running on any suitable computing platform as is known in the art, such as a network of computers configured to perform the functions as hereinafter described. The SISA management office front end 537 is a user interface that provides access and review capabilities for various members of the SISA management office so that communications into and out of the SISA center via interface 535 can be controlled and tracked for purposes of ensuring compliance with anti-collaborative regulations.

Notably, SISA management office platform 530 also includes a specification request and communications database 514a in communication with the SISA request management tool interface 535. This database is used to track and catalog all communications into and out of the SISA center via the platform 500, including specification requests and clarification requests of the type generally described above.

The tool platform 511 contains a request management tool 515 which, as depicted, is in secure electronic communication with both front ends 521 through security means 518 and 518′, which means may include firewalls, password encrypted secure tunneling architecture channels over the Internet, and the like. The request management tool serves as the primary mechanism for monitoring and enabling communications into and out of the SISA center during its operation under quarantine.

A new data request or specification request from one of the merging organizations, or from a member of one of the functional integration teams working with the SISA managing office, is entered into an electronic form provided by a user interface of one of the PMO front ends 522 or via the SISA front end 537. This form provides both open ended questions and questions having drop down menu selectable answers intended to make the requester enter sufficient data to both fully describe their new (or modified) request for legal review by the SISA management office, but also optimally in a manner that will ultimately enable the specialists within the SISA center to fully understand and complete the request without further communication from the requester.

The interface 535 routes requests automatically among the appropriate members of the SISA management office (steering committee, legal, etc.) to ensure that it is handled according to a secure information handling process, such as the exemplary handling process described above with respect to FIG. 4, before the request is cleared for electronic submission to the SISA center personnel via the request management tool 515 inside the SISA center facility. Legal counsel within the SISA center would then use the request management tool 515 to review and approve or reject the communication/request.

In similar fashion, clarification questions are sent out from the SISA center electronic tool platform 511 to the SISA management interface 535, reviewed by the legal counsel of the SISA management office via front ends 537, and then, if approved, routed to the appropriate pre-merger organization 520 or 520′ via the appropriate PMO front end 521. The questions can then be routed to appropriate persons to obtain the necessary clarifications and segregated among the various organizations 520 and 520′ as necessary.

Each front end 521 has associated with it a database 522 for tracking the status of all requests (legal status, escalations status, assignment status, IDs, and the like) and for keeping logs of all communications originating from the front end 521 into the SISA center.

Similarly, the request management tool 515 includes a similar database 514 maintained securely accessible only within electronic tool platform 511. This database 514 also primarily serves as a repository for information on the status of all data and specification requests, pending clarification questions, and communications logs, but also contains project scheduling information for the various specification request work plans (including timelines, status, expected completion dates, important benchmarks, etc.). In this manner, the request management tool provides high level managers within the SISA center the ability to monitor in real time the status of all projects within the SISA center while being certain that information security is being maintained throughout the quarantine period.

As depicted in FIG. 5, electronic tool platform 511 would also support other electronic tools needed by the SISA personnel, including productivity tools 516 (such as word processing applications, spreadsheet applications, and the like) and project management tools 517 (such as task assignment and tracking applications, interoffice email and scheduling applications and the like).

As will be readily appreciated by one skilled in the art, the use of an electronic platform such as that depicted in FIG. 5 to support an SISA according to embodiments of the invention has various advantages in addition to merely tracking the information into and out of the SISA center's. In particular since specification requests and clarification requests are submitted and transmitted via electronic forms using such a platform, the platform preferably can be configured with various productivity monitoring and management tools that automatically track timelines and status of various tasks associated with each request.

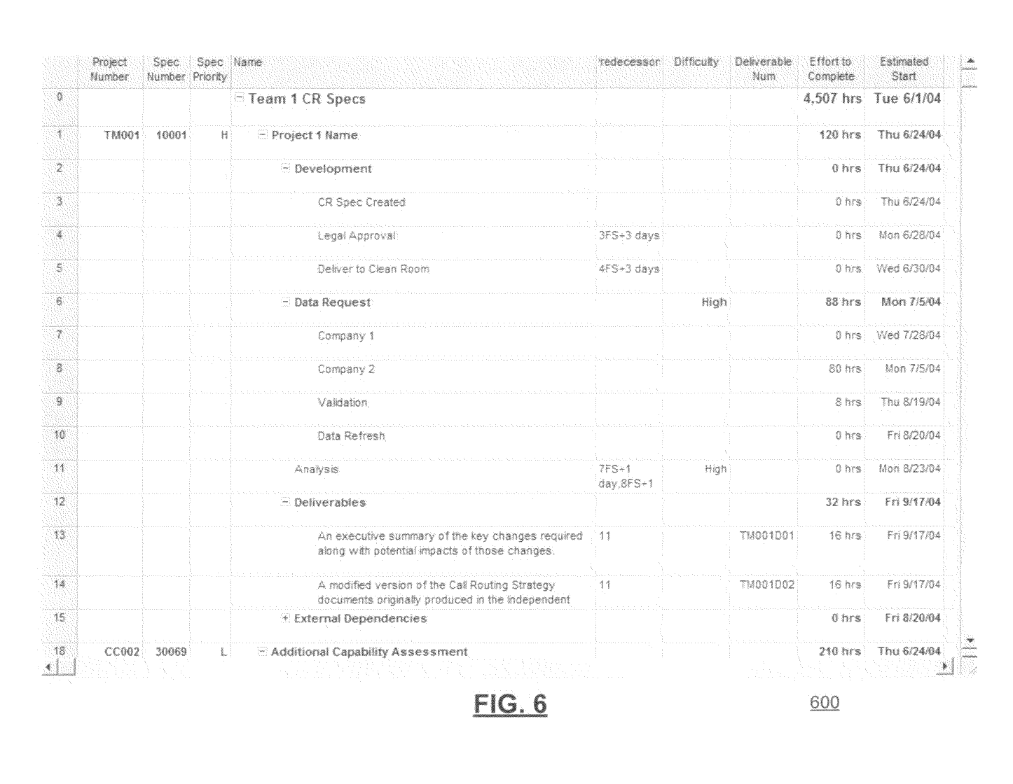

For example, FIG. 6 depicts a view of a sample specification request work plan 600 that could be provided to SISA personnel within the SISA center. This work plan could be accessible via a productivity tool running within the electronic tool computing platform of the SISA center and assist specialists within the SISA center in tracking deadlines, the progress of requests, and each individual's responsibilities concerning the requests and deadlines.

Additionally, members of the SISA management office could be provided with access to a similar, but sanitized or redacted, view of each specification work plan via the SISA management office's front end. In this manner, the SISA management office could be given on-demand insight into progress within the SISA center without compromising the security of information within the secure information repository.

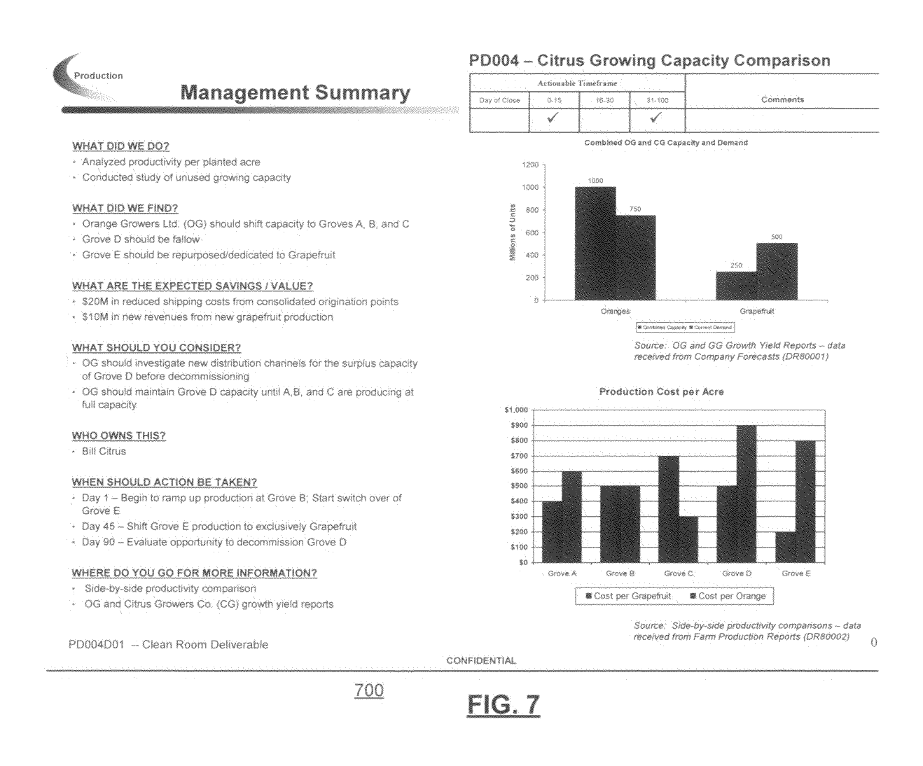

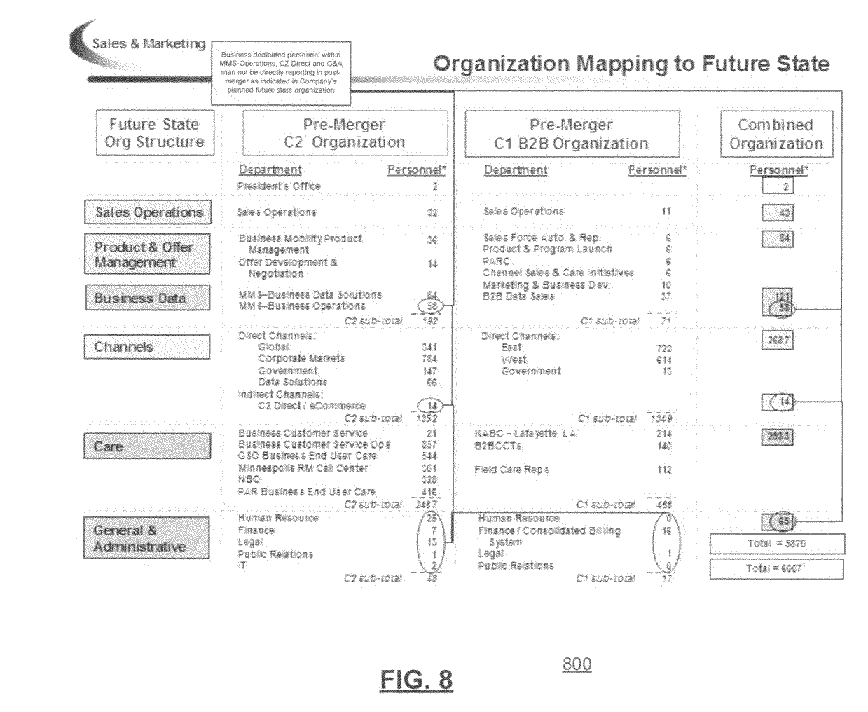

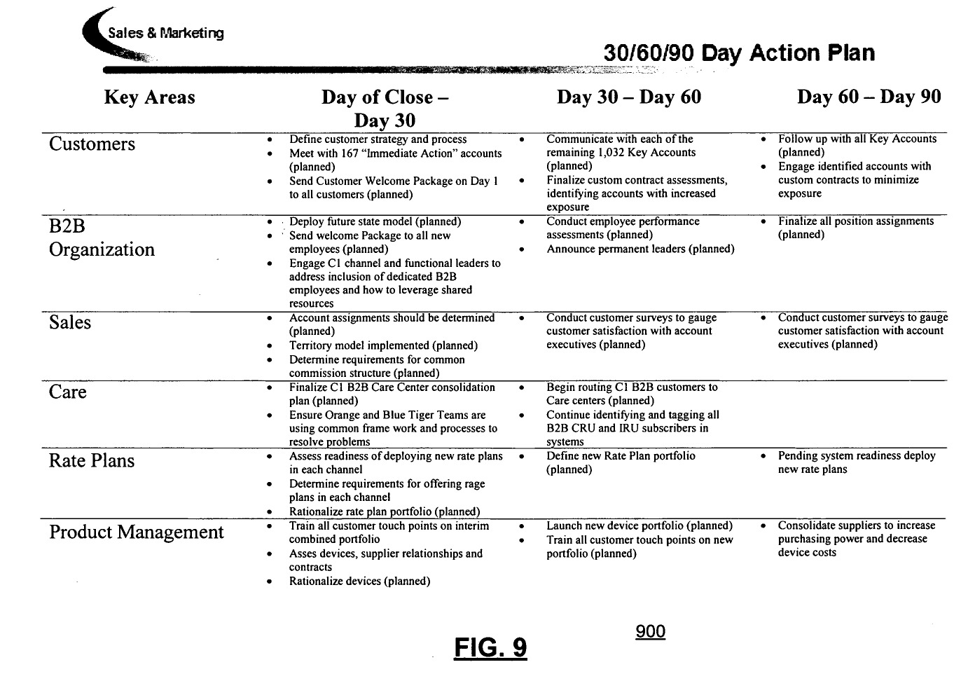

Additionally, as noted above, various deliverables are prepared during the quarantine of the SISA center for each specification request. For example, project deliverable packs can be prepared that provide functional and management level summaries, detailed financial projections and costs analyses, organizational restructuring mappings, memoranda, and action plans (which may include action items and timelines). By way of example, FIG. 7 depicts a sample high level management summary deliverable 700, FIG. 8 depicts a sample organizational mapping deliverable 800, and FIG. 9 depicts a multi-stage action plan deliverable 900 for key areas of the post-merger integration. As noted above, such deliverables would be presented to the management and/or external integration teams of the merging entities as appropriate following closing of the merger.

As will be readily understood by one of ordinary skill in the art, the above schematic diagrams and flow charts are meant to be illustrative of preferred operation of the secure information sharing architecture and the related platforms, tools and methods that are utilized to enable and support the architecture according to the present invention. Thus, the particular elements of the illustrated embodiments, including the number, ordering and relationship of the various steps, could be modified in various insubstantial ways while still providing tools and processes according to the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. It is therefore intended that the scope of the invention be limited not by this detailed description, but rather by the claims appended hereto.

1. A computing network architecture adapted to facilitate a secure information sharing architecture (“SISA”) for performing post-merger integration planning activities using collaborative information and data collected from one or more merging entities wherein the planning activities occur during a regulatory review period, said network architecture comprising:
a secure information facility electronic network located within a SISA center facility, said secure information facility network including a request management tool, one or more information repository databases containing said collaborative information, and a first communications tracking database, said request management tool being adapted to automatically populate said first request communications database;
a SISA management office electronic network located external to said SISA center, said SISA management office electronic network being in secure electronic communication with said secure information facility electronic network via an interface to said request management tool and said interface automatically populating a second request communications database, said SISA management office electronic network further having a SISA management office front end to permit management office personnel to review, create, and process specification requests for consideration by specialists quarantined within said SISA center facility in light of said collaborative information; and
a pre-merger organization front end in remote electronic communication with said interface, said pre-merger organization front end being in local communication with a third request communications database;
wherein said request communication databases catalog the transmission of information into and out of said SISA center facility in the form of specification requests and clarification requests.

2. The network architecture according to claim 1, wherein said request management tool is adapted to automatically route communications exiting said SISA center facility for review by legal counsel quarantined within said facility for transmitting said communications to said interface.

3. The network architecture according to claim 2, wherein said interface is adapted to automatically route communications entering said SISA center facility for review by legal counsel comprising said management office personnel and approval before transmitting said communications to said secure information facility electronic network.

4. The network architecture according to claim 1, wherein said specification requests comprise post merger integration research and planning directives originating from leaders of at least one of said merging entities, said specification requests being used to direct quarantined personnel within said SISA facility to perform corresponding post-merger integration research and planning using said collaborative data.

5. The network architecture according to claim 4, wherein said clarification requests comprise post merger integration research and planning petitions for additional guidance regarding a particular specification request previously received by SISA center facility.

6. The network architecture according to claim 1, wherein said front ends provide tracking and status update information concerning past specification requests and clarification requests.

7. The network architecture according to claim 1, wherein separate information repository databases are maintained for each merging entity that contributes a portion of said collaborative information for securing in said SISA center facility.

8. A secure information sharing architecture (“SISA”) for performing post-merger integration planning activities using collaborative information and data collected from one or more merging entities wherein the planning activities occur during a regulatory review period, said SISA comprising:
a SISA center secured from said merging entities and containing a secure information repository containing said collaborative information, communications into and out of said SISA center being monitored and controlled by an electronic request management tool and being tracked in a first communications tracking database that is automatically populated by said request management tool, said SISA center having personnel that includes business specialists assigned to one or more integration teams for said planning activities;
a SISA management office external to said SISA center and in communication with said SISA center via said request management tool, said SISA management office using a remote interface to said request management tool to communicate with said SISA center and said interface being adapted to automatically populate a second request communications database, said interface permitting said personnel of SISA management office to review, create, and process specification requests for consideration by specialists quarantined within said SISA center in light of said collaborative information; and
one or more external integration teams managed by one or more of said merging entities and corresponding to one or more of said integration teams within said SISA center, said external integration teams of said merging entity using a second front end application to communicate with said SISA center via said specialists in SISA center without violating anti-collaborative regulations;
wherein said request communication databases located in said SISA center, in said SISA management office, and in each pre-merger entity catalog the transmission of information into and out of said SISA center facility in the form of specification requests and clarification requests.

9. The secure information sharing architecture according to claim 8, wherein a request management tool is adapted to automatically route communications exiting said SISA center for review by legal counsel quarantined within said SISA center before being transmitting to said merging entities.

10. The secure information sharing architecture according to claim 9, wherein said remote interface is adapted to automatically route communications entering said SISA center facility for review by legal counsel outside said SISA center so that approval may be obtained before transmitting said communications to said SISA center electronically.

11. The secure information sharing architecture according to claim 8, wherein said specification requests comprise post merger integration research and planning directives originating from leaders of at least one of said merging entities, said specification requests being used to direct said specialists quarantined within said SISA center to perform corresponding post-merger integration research and planning using said collaborative data.

12. The secure information sharing architecture according to claim 11, wherein said clarification requests comprise post merger integration research and planning petitions for additional guidance regarding a particular specification request previously received by SISA center.

13. The secure information sharing architecture according to claim 8, wherein said front ends provide tracking and status update information concerning past specification requests and clarification requests.

14. The secure information sharing architecture according to claim 8, wherein separate information repository databases are maintained in said SISA center for each merging entity that contributes a portion of said collaborative information for securing in said SISA center facility.

15. A secure information sharing process for performing post-merger integration planning activities using collaborative information and data collected from one or more merging entities wherein the planning activities occur during a regulatory review period, said process comprising:
establishing a secure information sharing architecture (“SISA”), said architecture comprising a secure information facility electronic network located within a SISA center facility, said secure information facility network including a request management tool, one or more information repository databases containing said collaborative information, and a first communications tracking database, said request management tool being adapted to automatically populate said first request communications database;
establishing a SISA management office electronic network located external to said SISA center, said SISA management office electronic network being in secure electronic communication with said secure information facility electronic network via an interface to said request management tool and said interface automatically populating a second request communications database, said SISA management office electronic network further having a SISA management office front end to permit management office personnel to review, create, and process specification requests for consideration by specialists quarantined within said SISA center facility in light of said collaborative information;
receiving said specification requests from a pre-merger organization front end in remote electronic communication with said interface, said pre-merger organization front end being in local communication with a third request communications database;
cataloging the transmission of information into and out of said SISA center facility in said request communication databases in the form of said specification requests.

16. The process according to claim 15, wherein said request management tool is adapted to automatically route communications exiting said SISA center facility for review by legal counsel quarantined within said facility for transmitting said communications to said interface.

17. The process according to claim 16, wherein said interface is adapted to automatically route communications entering said SISA center facility for review by legal counsel comprising said management office personnel and approval before transmitting said communications to said secure information facility electronic network.

18. The process according to claim 15, wherein said specification requests comprise post merger integration research and planning directives originating from leaders of at least one of said merging entities, said specification requests being used to direct quarantined personnel within said SISA facility to perform corresponding post-merger integration research and planning using said collaborative data.

19. The process according to claim 18, further comprising sending clarification requests from said merging entity to said SISA center facility, wherein said clarification requests comprise post merger integration research and planning petitions for additional guidance regarding a particular specification request previously received by SISA center facility.

20. The process according to claim 15, wherein said front ends provide tracking and status update information concerning past specification requests and clarification requests.
